(19) United States
(12) Patent Application Publication
(10) Pub. No.: US 2006/0155678 A1
(43) Pub. Date: Jul. 13, 2006

(54) Fulfilling search methodology

(76) Inventor: Hassan Behbehani, Kuwait (KW)

Correspondence Address: Hassan Behbehani, P. O. Box : 1262 Safat, Safat, 13013, KW

(21) Appl. No.: 11/030,146

(22) Filed: Jan. 7, 2005

(51) Int. Cl. G06F 17/30

(52) U.S. Cl. 707/3

(57) ABSTRACT

The presented invention is to make life easy of information seekers. According to research web surfers look only few top results. Every time when user searches, Search Engine display the results according to Rankings. The Ranking is calculated in many ways but Parameters and their values have an important impact not only Rankings but also on search results as well. For example, If user searches for “List of Top IT vendors in Kuwait”, search engine searches and returns back the search results. Let's say user required information is in some document having format like “doc” or “PDF”. In first attempt, the search result pointing to required document may be hidden in thousand of search results but if parameter like “File format” is used, it may be included in user's in Top search results. To do this, there must be some mechanism from where user can easily decide that what parameters and their values may return its required search results. The presented invention is all this. This is the tool from where information seekers can take inspiration to get the required information quickly and easy.

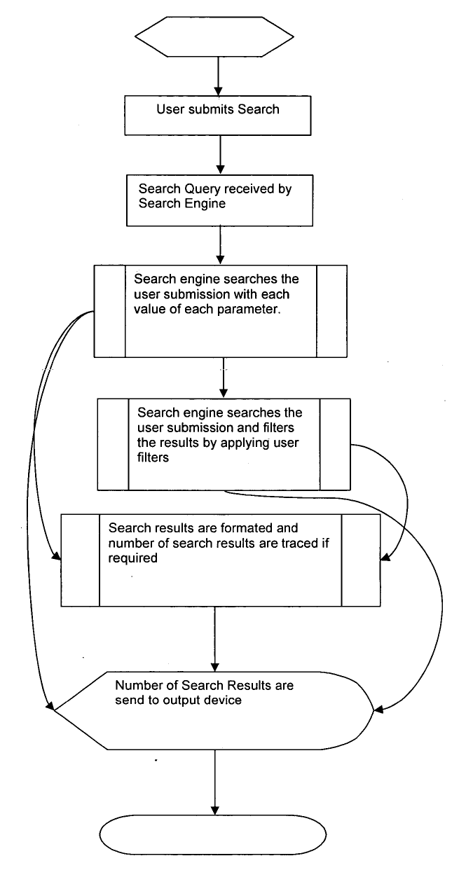

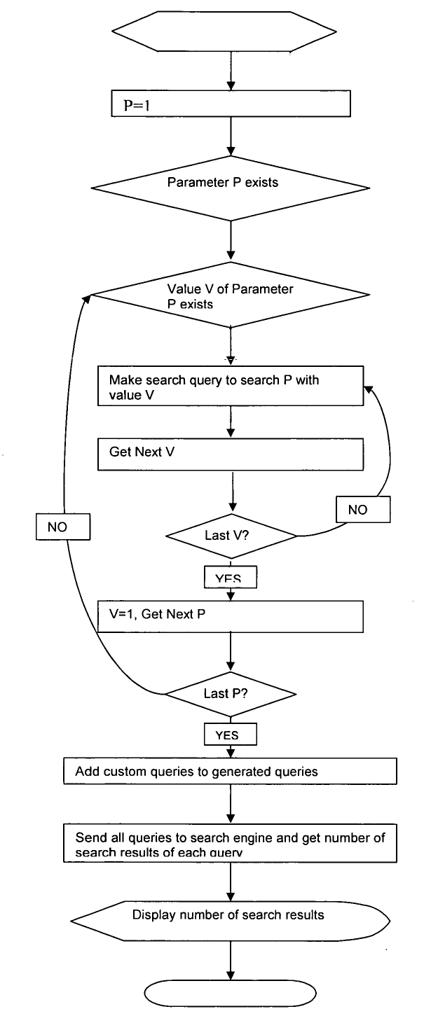

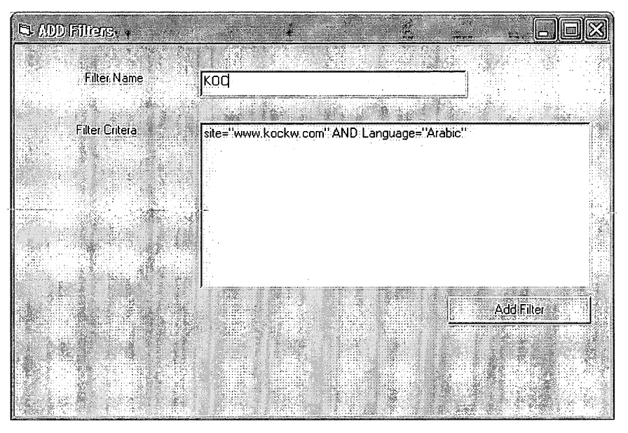

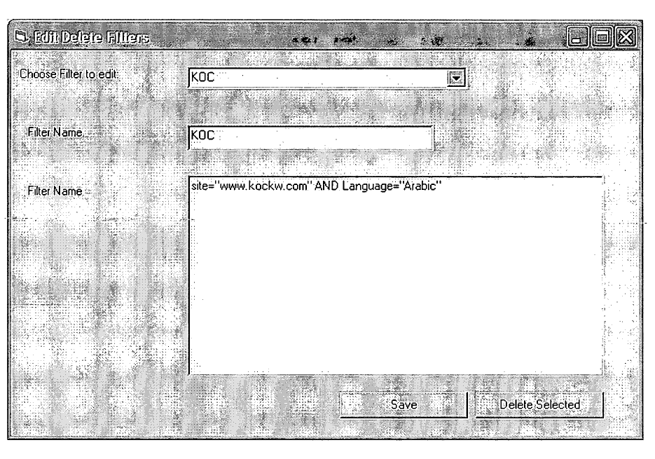

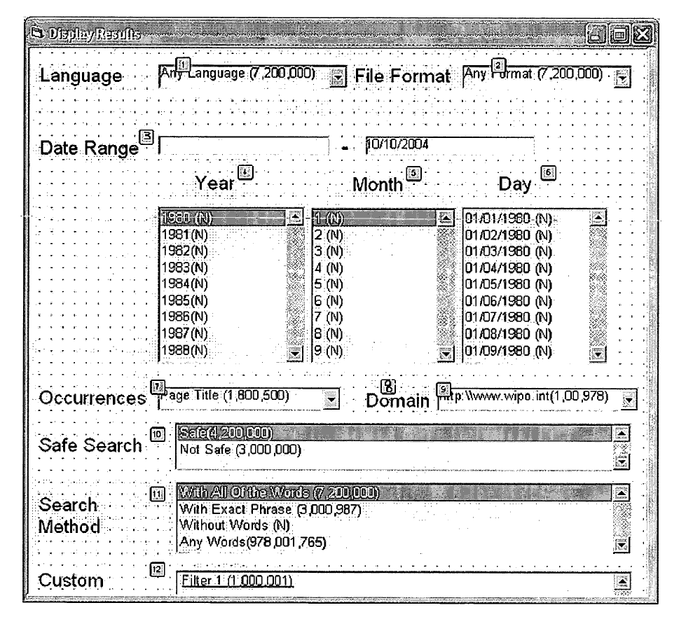

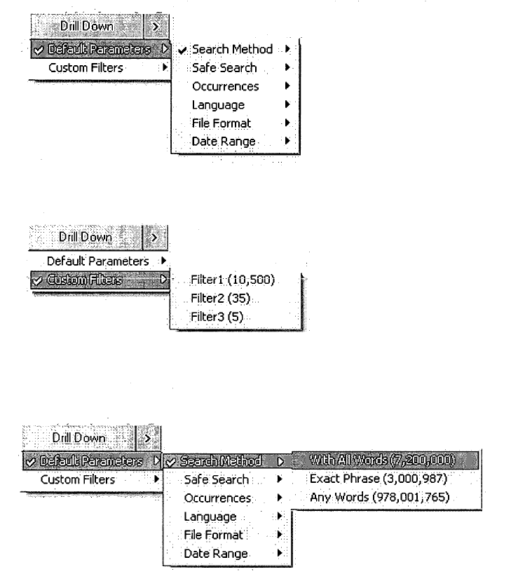

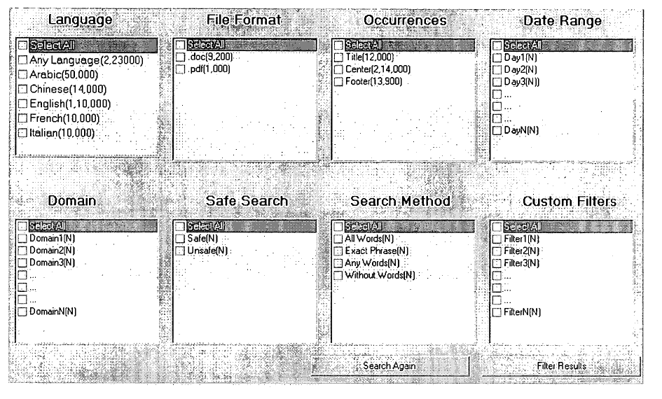

### BACKGROUND OF THE INVENTION

It may be heresy to say it, but how useful exactly are the millions of results we get when we Google something for example? Even if we only get a million hits for a search term or two it would take about 12 days to click through them all if we hit one every second. Numerous studies have shown that most of those million or more are utterly ignored because few people look beyond the first 20 or 30 results. The reason we get back so many results we never look at is because Google, partly, relies on keywords to work out what a page is about.

But the problem with keywords is that they are entirely free of context. The interpretation of keywords varies from even human to human. The exact meaning of keyword is almost impossible to trace until its context is known and as already said, keywords have no context. So if we search for “prince” Google has no idea if you mean the tennis racket, tinned salmon, computer training, pocket-sized pop star or Antoine de Saint-Exupéry.

But some search firms are going beyond keywords to put the context back and make looking for information less of a click fest. The technique is quite simple. To know the context, presence and knowledge of surroundings and associated events and even the background and history is required. Therefore Most of these approaches revolve around a companion program that sits on PC and is always present and monitors activities on PC and Report these events to appropriate analyzer or places this information in centralized memory so analyzers are able to pick this information.

As well as Blinkx, firms such as Copernic, X1, Enfish and others produce software that lurks in the background while you work on your PC and dynamically suggests links to web pages, locally-held documents and online news by working out what you are really interested in. Some of the tools, like Blinkx, will find video on the web, others like Copernic's forthcoming helper, let you save your searches and search within them.

Most of the tools produced by these firms do not require a browser window to be open. They just tick along in the background. There is a good reason for this such as If we control the search we control a lot of other things like e-commerce and advertising.

This explains why PC-based search tools (as opposed to web-based search tools) have suddenly become prominent.

The small firms producing PC search tools are about to get a lot more competition in the shape of Google, Microsoft and Yahoo.

A recent study by Nielsen/NetRatings showed that more and more people are going online without the use of a dedicated browser like Internet Explorer. Instead they use deskbars and helper programs to do their net surfing. If these firms can persuade you to use their tools then they have a hold, even if it is a benign one, on everything you do online.

In some respects they need to do this because only by selling ads tailored to what you are interested in can they make money and keep going.

But according to researches it also raises problems of privacy and security. They want that there must be an on/off switch. “If someone is working on sensitive documents or a major report one do not like the idea of having this information sent out to search engines on the web.”

Microsoft is planning to put tools built around a concept known as “Implicit Query” in its next version of Windows, called Longhorn, that is due in 2006/7. Like other firms do now, this technology tries to work out what you are really interested in and finds relevant documents and information for you.

Up till now many firms are trying to make the life easy for information seekers.

These efforts has brought many better aspects and technology. Similarly the said invention can also be considered as effort to improve the search engines pitfalls but it has chosen some different direction a new dimension rather than like other companies which are trying to expand traditional basis which have some basic problems. Some of them are enlisted below:
Too many search results are returned by the search engines
Difficult to target needed information quickly
Very difficult to filter the search results
Time consuming process to try different parametric values to return more specific results

When user tries to search with a combination of parameters, other filters and parameters are blind to user, which may hide ability to get needed information that may be very near to after adding further filters, therefore user is unable to estimate the correct combination that may return the needed information in few top links or that may lesser the number of search results returned. The invention has direct relationship with the number of attempts required to target the needed information. The more attempts means more useful invention is which clearly means invention is very effective for complex searches.

The presented invention tries to overcome the existing pitfalls as stated above and readily provides some big advantages as below:
Time Saving in searching required information
Lesser number of search results
Pre filtered search results are available readily i.e. preloaded
Search results can be returned according to user's preferences
User gets results for all the parameters at a glance
Immediate Information about Search Results Found Without Doing search individually every Parameter in Search Filters
Whenever user selects a filter or parameter all the search results in other parameters changed accordingly so consistency and integrity is always available
Provides information seeker with inspiration about “How to reach the desired information quickly and easily”

The presented invention can be considered as one of the first attempts to break the traditional barriers and to look the problem from a different view and direction and let the search engines and other companies not to consider as “The End” what has already been done. The said invention proves that “There's always room for improvement”

### BRIEF SUMMARY OF THE INVENTION

The presented technique makes the search process easy and smooth. According to research oftenly people used to view 20/30 top results returned by search engines or ads having text semantically similar to what user searched. Also if people want to search through existing search results or try the search with filters (commonly known as Advanced Search), they have to make a long effort. Many search engines provide this facility by capturing the values of pre-defined parameters such as Language (Arabic, English . . . etc), File Formats (MS Word, EXCEL, Acrobat, PowerPoint, images . . . etc), Occurrence (Title, text, URL . . . etc) and so on. Then each parameter may have predefined list of values such as in Language (Arabic, English . . . etc), File Formats (MS Word, EXCEL, Acrobat, PowerPoint, images . . . etc) where values in brackets indicate the value of parameter. Moreover there can be multiple selection of values of a parameter. If user has to try different parameters then applying these filters one by one takes lot of time. Moreover user does not have enough visibility I depth of search results i.e. user has no quick inspiration what parameters values should be applied to reach what is required in top results set. The presented invention provides the way to navigate, filter and refine search results quickly. When ever user searches some thing if required then pre-defined parameters and values are sent to search engines automatically and filled with the search results. In simple words, when user searches something then search engine sends the user back also number of results found for predefined parametric values. Through these number of search results users can quickly analyze the search results and can navigate to filtered results without any addition selection or typing efforts.

### BRIEF DESCRIPTION OF THE DRAWINGS

Sheet 1:

This sheet shows the flowchart of invented methodology if this method is implemented on search engine side. The process flow is not invention but it only shows a method to implement methodology at search engine server side.

The process is pretty simple. When user submits the information, search engine also applies the implicit query to search user submission with each value of all supported parameters and return the number of search results found for each value of each parameter. The search engine may also take user defined filters and returns the number of search results found for each filter.

Sheet 2:

This sheet shows the flowchart of invented methodology if this method is implemented by application itself. The process flow is not invention but it only shows an optional method to implement methodology from external application point of view.

The application takes each value of each supported parameter, makes a search query. In this way, application also makes search query for user defined filters. After creating search queries, these search queries can be submitted to search Engine either one by one or in form of batch. The query is executed and number of search results are retrieved. Again this is an optional flow and application may submit the query to search engine at the time of query creation.

Sheet 3:

This shows the creation of user defined filters. User can include any of the existing and supported parameters in this filter. A visual tool can also be provided to make custom filters. At the time of creation, syntax checking of filter is done. Error handling is also done at the time of creation and appropriate message are displayed to user.

Sheet 4:

This shows the edition and deletion of user defined filters. User can include any of the existing and supported parameters in this filter. A visual tool can also be provided to make custom filters. At the time of saving, syntax checking of filter is done. Error handling is also done at the time of saving and appropriate message are displayed to user.

Sheet 5:

This shows an optional working of the said invention. The idea is to display number of search result for each value of each parameter returned by search engine. For exemplary purpose, Google's Advanced Search parameters are used.

The annotations 1-11 show predefined and supported parameters. The search results returned again can also be grouped logically in case parameters do not have predefined set of values. In this case, the said invention analyze the search results and virtually creates set of values for such parameters. This phenomenon is simulated in marker 4 where date Range does not have any predefined value but user choose “10//10/2004” as the boundary date. The conversion of this into parameter values is shown in annotations 4-6 where the values shown are traced from search results returned by search engine. The “N” shows the number of search results. In this sheet, the values shown in brackets “( )” are number of search results returned by search engine.

Each value of each parameter has attached URL pointing to search results. This attached URL can be pre-generated or nay be generated at the time of user interaction.

Sheet 6:

This shows an optional working of the said invention. The number of search results can be shown in form of drill downs. The three figures on this sheet shows how user can immediately view number of search results and can do drill down to required information quickly. Each parameter in form of drill down has URL attached pointing to search results. This URL can be pre-generated or can be generated at the time of drill down.

Sheet 7:

This shows yet another way in which said invention can be used. This scrren can be shown when user executes search After further selection of parameters, user can filter these results according to selection. Also user can execute totally new search after selecting the required parameters which in turn again can be filtered further.

### DETAILED DESCRIPTION OF THE INVENTION

Microsoft is planning to put tools built around a concept known as “Implicit Query” in its next version of Windows, called Longhorn, that is due in 2006/7. Like other firms do now, this technology tries to work out what you are really interested in and finds relevant documents and information for you.

The invention presented here tries to go one step further. The presented invention introduces a method to search not only the users desired input but also to search the same automatically applying pre-defined filters and showing the number of results for each individual filter.

Filter here means more than the typical filters. A filter in a sense here may be pre-existing filter or user defined filters as well. For example, some common filters available on most of the search engines are Languages (Arabic, English . . . etc), File Formats (MS Word, MS Excel, Acrobat, PowerPoint, images . . . etc), Occurrences (Title, text, URL . . . etc) and so on. Moreover a filter may also comprises of user defined filters defined by the search engine itself implicitly or either giving user a facility to create the filter by choosing and combining different individual filters such as Language=Arabic and Country=Kuwait represents a filter to get the search results that have Arabic Language and Kuwait Country. Moreover a user may also define a filter and that may be included always whenever there is a command for the search engine. In short whenever user will send command for search there will also be in “implicit Query” of which Search Engine has to take care of.

Our solution provides the way to navigate, filter and refine search results quickly. When ever user searches some thing if required then pre-defined parameters and values are sent to search engines automatically and filled with the search results. In simple words, when user searches something then search engine sends the user back also number of results found for predefined parametric values. Through these number of search results users can quickly analyze the search results and can navigate to filtered results without any addition selection or typing efforts.

There are many search engines performing the user's submitted search in different ways. The most fundamental mechanism of search engines is to search user's submitted query. Mostly results returned by user's query has list of links pointing to the pages which contain user's submitted words. This presence of words is detected by different algorithims residing on search engine server. There are three basic algorithims almost in every search engine explicitly or implicitly and these algorithims run behind the scene.

1). All Words Search: This algorithim returns the pages which contain all the words submitted by user. This does not take care of the order of words submitted by the user rather it only make sure all the words should present.

2). Any Word Search: This returns all the pages which have any of the words submitted by the user.

3). Exact Phrase: This returns all the pages which have phrase exactly similar to the user's submitted phrase.

Now these three are fundamental search. Again Some search engines perform one of existing algorithims as default selection and when user's search is performed one additional thing is sent to the search engine implicitly i.e. the algorithim type used by the search engine (For example: 1, 2 or 3). If search engines provides the user with interface the choose which algorithim should use then user can choose the algorithim type and this value is submitted to server along with user's specified query. The algorithim type (for example) is called “parameter” and the value chosen by user for algorithim type is called “value of parameter” technically in computing.

Search engines providing parameters use these parameters to provide user with choices or user preferences. Search engines also provide an interface to users to select or set their choices i.e. set the values of parameter. Now these parameters may be in hundereds and may be a few. Users do not want to use always all the parameters. When user select or set the values of some of the parameters, other parameters are simply ignored or a default value is set for remaining parameters.

As in above example, search engines returned the user with user's specified algorithim type. Similarly Search engines provide many parameters to further facilitate the user to find more related results such as Language, Format, Date, Occurrence, Specific Domain . . . etc. Users choose these values and these value are submitted to search engine.

When user searches, user query is sent to the search engines along with the user preferences or user choices or user criteria. Sending user criteria to search engines may be performed by embedding this criteria into search URL through Parameters Markers though there are many ways to do this. Technically a parameter marker is a question mark (?) placed in the location of an input expression. In information technology, a parameter is an item of information—such as a name, a number, or a selected option—that is passed to a program by a user or another program. Parameters affect the operation of the program receiving them. Search engines perform search on user query including the user criteria and return only the pages that satisfy the user criteria.

If search results does not satisfy the user needs then user has to filter the search results with different parameters which is definitely time consuming. This becomes more cumbersome if unluckily there is no result against some filters. Moreover selection of one parameter may affect other parameters as well. In short, it takes lot of inconvenience for user to explore all the options in order to reach their required information.

Our solution provides the way to overcome these problems. The presented invention reveals a way to present the user with a whole glance of search results so that user can quickly decide which filter (a combination of parameters with various values) may suit user's needs and can quickly navigate to that results set.

The invention comprises basically filters which can be displayed in various ways such as in form of Tabs, wherein each tab having criteria to make the search string or page listing parameters and their values and filters or in form a drill down where user can go into more depth after performing simple search or in form of some menus or context menus whatsoever is suitable according to the situation.

The invention also contains a facility to define custom filters. Below are mentioned some of the customized filters examples. The creation of filters is nothing bust concatenating more than one parameters through some operator.
1. Search String & algorithim type=“ALL” WHERE Domain=“.KW” OR Language=“Arabic”
2. Search String WHERE Document Type=“.pdf” AND Language=“Arabic”
3. Search String WHERE Date Between ‘10/10/2002’ AND ‘01/01/2004’

The examples above are for explanatory purposes. The said invention facilitates the filtering in text as well as in the form of visual filter formation. The main purposes of the filters is not introduce the filtering facility but to form filters to be included in other parameters list so that when user performs a search, search results for filters will also be returned. In other words, filters can be considered as similar to parameters but can have multiple parameters. When number of search results are populated for parameters such as “Language=Arabic” similarly number of search results will be returned for all the defined filters such as a filter named “KWFilter”

The process is simple. When user submits the search, all the required parameters and their values are also submitted. The number of search results returned for each parameter and/or filters then displayed against each parameter (parameter value) so that user may have exact idea of search using different parameter sets (filters).

The process explained above may have different technical implementations as explained in drawings submitted along with this application. Similarly tracking number of search results may also have different technical implications.

One scenario in this regards is when user submits the search, all the required parameters and their values are also submitted. The number of search results returned for each parameter and/or filters then displayed against each parameter (parameter value) so that user may have exact idea of search using different parameter sets (filters).

While in the second scenario when user submits the search, search results are found. Within the found search results, number of search results can be tracked for each value of each parameter which requires some additional functionality such as a small query analyzer or some sort of local search engine that has the ability to scan found search results and then return number of search results found for each value of each parameter including customized filters and new parameter or even new value of a specific parameter. However there is huge technical challenge to implement this methodology but it requires less bar on the search engine itself.

In yet another implementation, each search result returned may have an additional tag attached for the identification of different values and parameters against which this search result may be returned.

In short, the said methodology can be used and implemented in numerous ways. That's why it is almost impossible claim any of the technical implementation which has associated risk of limited patent scope of this application.

Lets take an example of Google Advanced Search which will help to have more clear idea of this invention. If we look google advance search page, it has first 4 boxes to ask the user type of search, user wants google to execute such as with all words, with exact phrase, with at least one of the words and without words. User can use a combination of these boxes which may be called as filter and if we name it, it may be called some customized filter. For example, If we search some sentence and filter this sentence again by typing without words box then virtually it has been customized and we have included more than one parameters as well.

Google Advanced Search has also a parameter known as Language which returns the user only the pages that are written in the specified language. Language parameter has predefined set of values and user can only choose from one of the value

With File Format, Google will return only the web pages having specified format. File Format parameter again has predefined set of values from which user can choose desired value.

Data parameter accepts two values. First is Start Date and second is Finish Date. Google will return the pages that were updated in the specified date range.

Numeric Range is also range based parameter where user can provide start and Finish Range.

Using Occurrences parameter user can specify the specific portion of document or web page that should be included in search. Again Occurrences parameter has predefined set of values and user can choose one value.

Domain Return only the results from the domain specified

There is another parameter that can be chosen by the user weather to execute safe search or not.

The above mentioned parameters were taken for exemplary purposes. Now if information seeker is not satisfied the results, he/she may be interested in trying out other parameters as well. These are many parameters and its time consuming practice to try each parameter. Moreover information seeker can not guess which combination would be more suitable to hit his/her required results. So when user search for a specific sentence all the parameters present on the advanced search page are filled with number of search results returned by search engine for each value of each parameter.

What I claim as my invention is:

1) A system and method of Advanced searching and displaying search results, the method comprising the steps:
Generating the search queries dynamically for each value of each parameter
Submitting the each search query to desired search engine(s)
Getting the number of search results returned by search engine for each search query
Displaying the number of search results for each search query in appropriate form against each value of each parameter

2) A system and method as claimed in claim 1, wherein Generating the search queries step comprises the following steps:
Dynamic search queries can either be comprised of single parameter or multiple parameters concatenated through different kind of operators supported by desired search engine

3) A system and method as claimed in claim 1, wherein a tool is provided to build and manage filters and criteria comprising of parameters and values supported by search engines

4) A system and method as claimed in claim 1, wherein Submitting the each search query to desired search engine(s) step can be performed through any kind of medium and methodology that has the capability to do so

5) A system and method as claimed in claim 1, wherein Submitting the each search query to desired search engine(s) step multiple search queries may be submitted to search engine if desired search engine has capability to do so

6) A system and method as claimed in claim 1, wherein Getting the number of search results returned step comprises:
The number of search results may be known from search results page returned by the search engine either by tracking the variable holding the number of search results or formatting and trimming the actual page contents returned by search engine

7) A system and method as claimed in claim 1, wherein Getting the number of search results returned step comprises:
The number of search results may be known directly by using desired search engine facility if available

8) A system and method as claimed in claim 1, wherein a URL can be formed to execute search query on desired search engine(s) if supported by search engine

9) A system and method as claimed in claim 8 wherein the said system attaches the URL generated with search query

10) A system and method as claimed in claim 1, wherein last step in claim 1 comprises attaching the URL generated in step 8 with number of search results

11) A system and method as claimed in claim 1 wherein a search query can be accessed and executed through a URL attached with number of search results

12) A system and method as claimed in claim 1 wherein a parameter may have predefined set of values or user provided value

13) A system and method as claimed in claim 1 wherein said methodology can be used to create new parameters at specified search engine which in turn must be supported by specified search engine

14) A system and method as claimed in claim 1 wherein said methodology can be used to edit existing parameters and enabling and disabling existing parameters at specified search engine which in turn must be supported by specified search engine

15) A system and method as claimed in claim 1 wherein the said method provides an interface accessible by external applications or processes

16) A system and method as claimed in claim 1 wherein the said method can be invoked and or used by internal or external application or method
